(19) United States
(12) Patent Application Publication
(10) Pub. No.: US 2026/0217049 A1
(43) Pub. Date: Jul. 30, 2026

(54) CARD PRODUCT IMPLEMENTING MULTIPLE SECURITY FEATURES AND RELATED ANTI-FRAUD TECHNIQUES

(71) Applicant: Monadnock Paper Mills, Inc., Bennington, NH (US)

(72) Inventors: Rajan Raman Iyer, Lawrenceville, GA (US); Frank J. Shaffer, Merrimack, NH (US); John Brian Cooper, Hants (GB); Heather Starkey, Peterborough, NH (US); Michael Jay Ouellette, Antrim, NH (US)

(21) Appl. No.: 19/453,524

(22) Filed: Jan. 20, 2026

Related U.S. Application Data
(60) Provisional application No. 63/749,978, filed on Jan. 27, 2025.

(51) Int. Cl. B42D 25/333; B42D 25/36; B42D 25/20; B42D 25/27

(52) U.S. Cl. CPC B42D 25/333; B42D 25/36; B42D 25/27; B42D 25/285

(57) ABSTRACT

A card product implementing a plurality of security features is disclosed. The disclosed card product may be a multi-layer body, of paper and/or plastic composition, which implements at least a plurality of security features (e.g., two or more) that are configured, in accordance with some embodiments, to visibly alter the appearance of the card product in the event of tampering by a fraudster. The implemented security features, individually and/or collectively, may serve to signal to retail staff and consumers that the card product has suffered tampering and, thus, the integrity of financial information pertaining to the card has been compromised.

### CROSS-REFERENCE TO RELATED APPLICATIONS

This patent application claims the benefit of U.S. Provisional Patent Application No. 63/749,978, titled “Card Product Implementing Multiple Security Features and Related Anti-Fraud Techniques,” filed on January 27, 2025, which is herein incorporated by reference in its entirety.

### FIELD OF THE DISCLOSURE

The present disclosure relates to card products and, more particularly, to gift card products implemented with safety features which deter fraud.

### BACKGROUND

Generally, gift cards are prepaid, stored-value money cards issued by a retailer or bank. The monetary value of a gift card can be stored directly on the card or in an external account maintained by a financial institution. Gift card redemption is often backed by an online, electronic system for authorization. Some gift cards can be reloaded by payment and, thus, can be used multiple times.

### SUMMARY

The subject matter of this application may involve, in some cases, interrelated products, alternative solutions to a particular problem, and/or a plurality of different uses of a single system or article.

A first example embodiment provides a card product. The card product comprises a base layer and a plurality of abradable opaque coverings disposed over the base layer. The card product implements at least two of the following security features: (a) as a first security feature, at least one of the opaque coverings covers sensitive information hosted by the card product, while at least one other of the opaque coverings does not cover sensitive information and so serves as a decoy; (b) as a second security feature, the opaque coverings are of a custom, non-traditional shape; (c) as a third security feature, a reference image is printed on the card product, wherein the reference image matches a shape of the opaque coverings; (d) as a fourth security feature, an image and/or text is printed across at least one of the opaque coverings, and a reference image is printed on the card product, wherein the reference image matches the printed image; (e) as a fifth security feature, at least one of the opaque coverings includes a border portion of a first color and an interior fill portion of a second color which differs from the first color; (f) as a sixth security feature, the card product further comprises a color-changing layer disposed over the base layer and having the plurality of opaque coverings disposed thereover, wherein the color-changing layer is configured to irreversibly change color when sufficient pressure and/or thermal energy has been applied thereto; (g) as a seventh security feature, the card product further comprises a solvent indicator configured for chromatographic movement of coloration through the card product when contacted by a solvent; (h) as an eighth security feature, at least one of the opaque coverings is adhered via a cross-linkable adhesive; and (i) as a ninth security feature, the card product further comprises a digital watermark.

In some cases, the custom, non-traditional shape is chevron-shaped. In some cases, the custom, non-traditional shape comprises a plurality of adjacent shapes which are spaced apart from one another with corresponding gaps intervening therebetween.

In some cases, the third security feature further includes a message warning against purchase of the card product if the reference image and opaque coverings are of differing shapes.

In some cases, the fourth security feature further includes a message warning against purchase of the card product if the reference image and/or text and the printed image are different.

In some cases, the color-changing layer comprises at least one of: a pressure-sensitive material; and a thermally sensitive material. In some cases, the color-changing layer comprises a leuco dye. In some cases, the color-changing layer comprises protonated bentonite clay. In some cases, the color-changing layer comprises silica. In some cases, the color-changing layer further comprises a paper material. In some cases, the color-changing layer further comprises a polymer material. In some cases, the sixth security feature further includes a message warning against purchase of the card product if a color change is present in the card product.

In some cases, the solvent comprises at least one of acetone, isopropyl alcohol, ethyl acetate, glycol ether, and mineral spirits. In some cases, the solvent indicator is at least partially embedded in an underlying layer. In some cases, the solvent indicator is linear in shape. In some cases, the solvent indicator is non-linear in shape. In some cases, the seventh security feature further includes a message warning against purchase of the card product if a color change is present in the card product.

In some cases, the cross-linkable adhesive is an ultraviolet (UV) cross-linkable adhesive.

In some cases, the digital watermark comprises a barcode printed on at least one of the opaque coverings.

A second example embodiment provides a gift card comprising the card product of the first example embodiment above.

A third example embodiment provides a lottery scratchcard or ticket comprising the card product of the first example embodiment above.

A fourth example embodiment provides food packaging comprising the card product of the first example embodiment above.

A fifth example embodiment provides medication packaging comprising the card product of the first example embodiment above.

A sixth example embodiment provides a card product. The card product comprises a base layer. The card product further comprises a color-changing layer disposed over the base layer, wherein the color-changing layer is configured to irreversibly change color when sufficient pressure and/or thermal energy has been applied thereto. The card product further comprises at least one abradable opaque covering disposed over the color-changing layer.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 illustrates a cross-sectional view of a card product configured in accordance with an embodiment of the present disclosure.

FIG. 2 illustrates a card product implementing a security feature in accordance with an embodiment of the present disclosure.

FIG. 3 illustrates a card product implementing another security feature in accordance with an embodiment of the present disclosure.

FIG. 4 illustrates a card product implementing another security feature in accordance with an embodiment of the present disclosure.

FIG. 5 illustrates a card product implementing another security feature in accordance with an embodiment of the present disclosure.

FIG. 6A illustrates a cross-sectional view of a card product configured in accordance with an embodiment of the present disclosure.

FIG. 6B illustrates the card product of FIG. 6A implementing another security feature in accordance with an embodiment of the present disclosure.

FIG. 7 illustrates a card product implementing another security feature in accordance with an embodiment of the present disclosure.

FIGS. 8A-8B illustrate a card product implementing another security feature in accordance with an embodiment of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

### DETAILED DESCRIPTION

A card product implementing a plurality of security features is disclosed. The disclosed card product may be a multi-layer body, of paper and/or plastic composition, which implements at least a plurality of security features (e.g., two or more) that are configured, in accordance with some embodiments, to visibly alter the appearance of the card product in the event of tampering by a fraudster. The implemented security features, individually and/or collectively, may serve to signal to retail staff and consumers that the card product has suffered tampering and, thus, the integrity of financial information pertaining to the card has been compromised. Numerous configurations and variations will be apparent in light of this disclosure.

### General Overview

Fraud is a multi-million-dollar problem facing the gift card industry, and fraudsters are constantly evolving in their methods for stealing sensitive information, such as personal identification numbers (PINs), barcodes, and the like. To combat this, many companies have begun to design and utilize more sophisticated security features on their gift cards. However, the burden of verifying that a gift card has not suffered tampering prior to purchase generally falls on consumers.

One major example of gift card fraud involves a fraudster taking a gift card from a store, removing the scratch-off covering(s) to reveal sensitive information (e.g., a PIN, etc.), copying that sensitive information for later use, and applying new scratch-off covering(s) without the awareness of the consumer. Given this and other prevalent methods of gift card fraud, there is a need for greater security measures to protect consumers.

Thus, and in accordance with some embodiments of the present disclosure, a card product implementing a plurality of security features is disclosed. The disclosed card product may be a multi-layer body, of paper and/or plastic composition, which implements at least a plurality of security features (e.g., two or more) that are configured, in accordance with some embodiments, to visibly alter the appearance of the card product in the event of tampering by a fraudster. The implemented security features, individually and/or collectively, may serve to signal to retail staff and consumers that the card product has suffered tampering and, thus, the integrity of financial information pertaining to the card has been compromised. In this manner, card products configured as described herein may serve to deter fraudsters with greater efficacy than existing approaches.

As discussed herein, the disclosed card product may be provided, for example, in the form of a gift card issued by a retailer or bank, in accordance with some embodiments. It should be noted, however, that the present disclosure is not intended to be so limited, as numerous other forms are possible, in accordance with other embodiments. For example, the card product may be (or otherwise may be implemented with) a lottery scratchcard or ticket, food packaging, or medication packaging, to name a few options. More generally, the disclosed card product may be utilized in any of a wide range of security applications where there is a high risk of fraudulent activity that requires authentication at the time of purchase or post-purchase. Numerous suitable uses and applications will be apparent in light of this disclosure.

Some embodiments may realize one or more advantages or benefits as compared to existing approaches. For example, the more security features added to a card product produced as described herein, the greater the likelihood that a consumer could be alerted of tampering prior to purchase. Also, inclusion of multiple security features in a single card product produced as described herein may provide for certain synergistic effects that significantly increase the difficulties which fraudsters must defeat to commit fraud. That is, even if a fraudster were to find a workaround for one of the included security features, it is unlikely that all included security features could be defeated given their functional layering and interrelationships. Furthermore, with a wide range of security features available, vendors can customize a card product produced as described herein with specific selections and combinations of security features, both overt and covert, allowing for decisions on implemented security features to account for factors including, for example, the perceived value in reducing fraud, the cost of implementation, and governmental regulations, among others.

### Card Product Structure

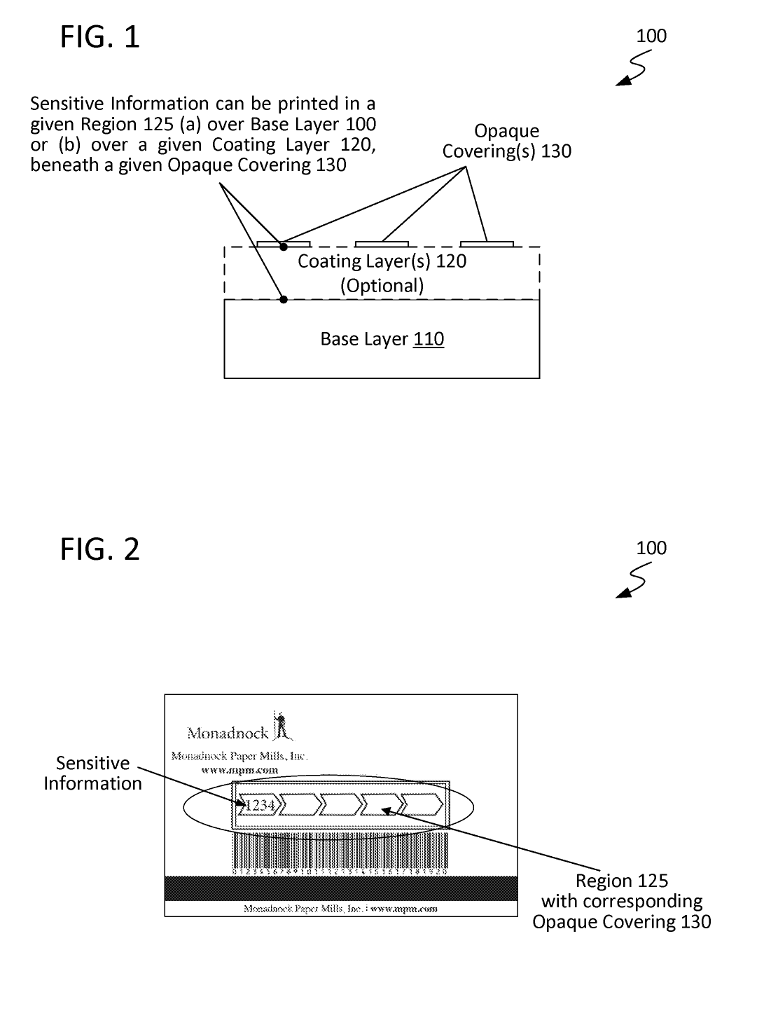

FIG. 1 illustrates a cross-sectional view of a card product 100 configured in accordance with an embodiment of the present disclosure. As can be seen, card product 100 generally may be constructed as a multi-layer body including a base layer 110 and one or more coating layers 120 disposed thereover. Card product 100 also may include a plurality of designated regions 125 over coating layer(s) 120 at which sensitive information, such as a personal identification number (PIN), serial number, barcode, or the like, may be printed. Furthermore, card product 100 may include a corresponding plurality of opaque coverings 130 disposed over those regions 125. Additionally, as discussed herein, card product 100 may be produced with any of a wide range of security features and, more specifically, may be produced with at least a plurality (e.g., two, three, four, or more) of such security features, in accordance with some embodiments. Each of these elements is discussed in turn below.

As previously noted, card product 100 may include a base layer 110. The material composition of base layer 110 may be customized, as desired for a given target application or end-use. Base layer 110 may comprise a paper material and/or a polymeric material (e.g., a plastic or composite). In some embodiments, base layer 110 may be formed with only a single constituent material, whereas in other embodiments, multiple constituent materials may be utilized. Additionally, the thickness and uniformity (or non-uniformity) of base layer 110 may be customized, as desired for a given target application or end-use. Other suitable configurations and materials for base layer 110 will depend on a given target application or end-use and will be apparent in light of this disclosure.

Also, as previously noted, card product 100 optionally may include one or more coating layers 120. Generally, a given coating layer 120 may be included in the structure of card product 100, for example, to help produce a smooth, printable surface meeting one or more target characteristics or conditions, in accordance with some embodiments. A given coating layer 120 may be disposed directly on (e.g., in direct physical contact with) or indirectly on (e.g., with one or more physically intervening layers) the underlying base layer 110. More generally, a given coating layer 120 may be laminated, in part or in whole, on base layer 110 (e.g., using a suitable adhesive or other suitable technique). Also, the material composition of a given coating layer 120 may be customized, as desired for a given target application or end-use. In some embodiments, a given coating layer 120 may be formed with only a single constituent material, whereas in other embodiments, multiple constituent materials may be utilized. Additionally, the thickness and uniformity (or non-uniformity) of a given coating layer 120 may be customized, as desired for a given target application or end-use.

In some embodiments, a given coating layer 120 may comprise one or more pigments. Suitable pigments may include, for example, any one (or combination) of kaolin clay, precipitated calcium carbonate, ground calcium carbonate, titanium dioxide, and silica, among others. In some embodiments, a given coating layer 120 may include a pigment comprising protonated bentonite clay or silica which has been modified, for instance, to interact with a leuco dye (e.g., to promote a visible color change, such as is discussed below in relation to some embodiments). In some embodiments, the pigment(s) used in the formulation of a given coating layer 120 may be of a singular source, whereas in other embodiments, a mixture of two or more pigment sources may be utilized. As will be appreciated in light of this disclosure, selection of a given pigment for use in a given coating layer 120 may depend on any of a wide range of factors. For example, pigment selection may depend, at least in some instances, on particle size(s) and shape(s) preferential to achieving a card product 100 exhibiting one or more target characteristics (e.g., sheet gloss, printability, enhanced optical properties, provision of an activator which serves to induce a color change, etc.).

In some embodiments, a given coating layer 120 may comprise one or more binders, including any of a wide range of latexes and starches. For instance, in some embodiments, a given coating layer 120 may comprise any one (or combination) of styrene-acrylate latex, vinyl acrylic latex, styrene-butadiene-acrylate latex, cooked corn starch, and chemically modified cooked cornstarch (e.g., where the modification of the cornstarch was done to impart a different chemical functionality that enhances film formation, film performance, and/or processing capabilities, especially regarding viscosity). As will be appreciated in light of this disclosure, it may be desirable, at least in some instances, to utilize a latex having a low level of volatile organic compounds. It should be noted, however, that the present disclosure is not intended to be so limited, as in accordance with some other embodiments, achievement of target levels of adhesion and surface functionalities may be of primary concern.

In some embodiments, a given coating layer 120 may comprise one or more filler materials. When included, a given filler material may serve, at least in part, to promote sufficient spacing of pigment particles in a given coating layer 120, for instance, to obtain a given set of target optical properties for card product 100.

In accordance with some embodiments, it may be desirable to manufacture a card product 100 which resembles more closely the look and feel of a plastic card using raw material(s) generally considered more sustainable than plastic. To such end, card product 100 may include, for example, one or more coating layers 120 characterized by a gloss measurement (e.g., a 65° gloss measurement) in the range of about 3–20 (e.g., about 3–5, about 5–10, about 10–15, about 15–20, or any other sub-range in the range of about 3–20). In some cases, a coating layer 120 having a gloss measurement in the range of about 8–12 (e.g., about 8–10, about 10–12, or any other sub-range in the range of about 8–12) may be utilized.

As will be appreciated in light of this disclosure, the selection of pigment(s), binder(s), and/or filler(s) in the formulation of a given optional coating layer 120 may be customized, as desired for a given target application or end-use (e.g., to accommodate the needs of multiple printing presses, ink type, drying requirements, etc.). Other suitable configurations and materials for optional coating layer(s) 120 will depend on a given target application or end-use and will be apparent in light of this disclosure.

Furthermore, as previously noted, card product 100 may include one or more opaque coverings 130. A given opaque covering 130 may be disposed directly on (e.g., in direct physical contact with) or indirectly on (e.g., with one or more physically intervening layers) a given underlying coating layer 120. By design, a given opaque covering 130 may be configured to adhere to a given coating layer 120 (or other underlying layer) in a manner and degree which permits ready abrasion thereof by a user intending to scratch off said opaque covering 130 to reveal sensitive information printed thereunder.

The material composition of a given opaque covering 130 may be customized, as desired for a given target application or end-use. In some embodiments, a given opaque covering 130 may comprise a latex material, optionally colored with one or more pigments and/or dyes. In an example case, a given opaque covering 130 may comprise a silver-colored latex ink which has been printed on a given underlying layer. Other suitable configurations and materials for opaque covering(s) 130 will depend on a given target application or end-use and will be apparent in light of this disclosure.

Additionally, as previously noted, card product 100 may be produced with any of a wide range of security features. A discussion of some suitable security features follows immediately below.

### First Security Feature

FIG. 2 illustrates a card product 100 implementing a security feature in accordance with an embodiment of the present disclosure. As can be seen here, card product 100 may include a plurality of regions 125 covered by a corresponding plurality of opaque coverings 130, the quantity, arrangement, and distancing (e.g., pitch or spacing) of which may be customized, as desired for a given target application or end-use. Meanwhile, sensitive information (e.g., a PIN, serial number, barcode, or the like) may be printed within one or more of the available regions 125, with the other regions 125 intentionally remaining empty and thus serving as decoys.

With implementation of this security feature, a fraudster cannot be sure which covered region 125 is the one having the sensitive information, and so it could become necessary to scratch off multiple opaque coverings 130 in effort to reveal that sensitive information. As such, a fraudster would need to convincingly replace or restore all scratched-off opaque coverings 130, increasing the effort required to conceal any tampering and thus serving as a deterrent.

### Second Security Feature

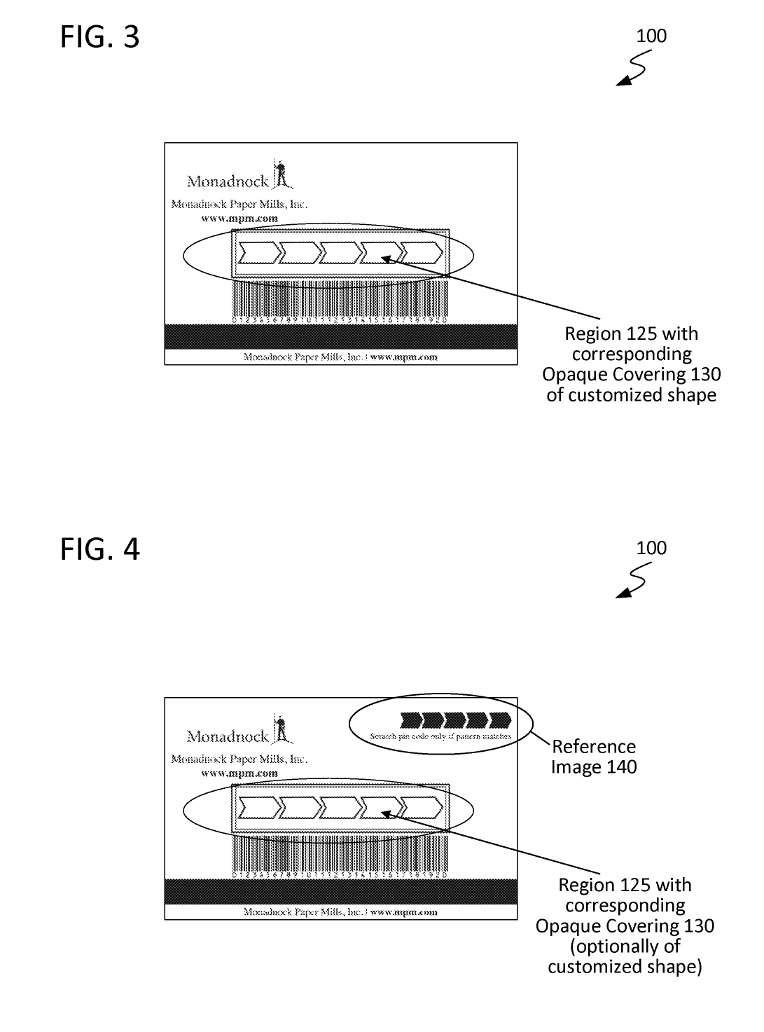

FIG. 3 illustrates a card product 100 implementing another security feature in accordance with an embodiment of the present disclosure. As can be seen here, much like with the embodiment discussed above in relation to FIG. 2, card product 100 again may include a plurality of regions 125 and a corresponding plurality of opaque coverings 130. In this embodiment, however, any (or all) included opaque coverings 130 may be provided with a specifically chosen shape which is considered non-standard or non-traditional in a given relevant industry and which may be customized as desired for a given target application or end-use. For instance, in some cases, a given opaque covering 130 may be of polygonal geometry (e.g., triangular, square, rectangular, pentagonal, hexagonal, etc.). In some such instances, the geometry may be substantially or mostly polygonal, having one or more optionally rounded corners. In some cases, a given opaque covering 130 may be of closed-curve geometry (e.g., circular, elliptical, oval, etc.). In some cases, a given opaque covering 130 may be of U-shaped or V-shaped geometry (e.g., chevron-shaped). In some cases, a notch feature, a convex feature, and/or a concave feature, of angle or curved shape, may be incorporated into the selected basic geometry. In some embodiments, all opaque coverings 130 may be of substantially the same geometry (e.g., a homogeneous plurality). In other embodiments, at least one opaque covering 130 may differ in geometry from at least one other opaque covering 130 (e.g., a heterogeneous plurality).

With implementation of this security feature, a fraudster would need to convincingly replace or restore scratched-off opaque coverings 130 of one or more customized or otherwise non-standard shapes. Given the limited availability and range of counterfeit opaque coverings, this security feature increases the effort required to conceal any tampering and thus serves as a deterrent.

### Third Security Feature

FIG. 4 illustrates a card product 100 implementing another security feature in accordance with an embodiment of the present disclosure. As can be seen here, much like with the embodiments discussed above in relation to FIGS. 2-3, card product 100 again may include a plurality of regions 125 and a corresponding plurality of opaque coverings 130, optionally of one or more customized shapes. In this embodiment, however, card product 100 further may include a reference image 140 printed thereon and a message warning the consumer that if the observable shape(s) of the opaque covering(s) 130 do not match reference image 140, then tampering may be suspected. For instance, if reference image 140 shows a plurality of opaque coverings 130 of chevron shape, but the opaque coverings 130 seen directly on card product 100 are of rectangular shape, tampering may be suspected.

With implementation of this security feature, a fraudster would need to replace or restore scratched-off opaque coverings 130 of exactly the same shape(s) seen in reference image 140 or else remove both reference image 140 and the warning message altogether. This increases the effort required to conceal any tampering and thus serves as a deterrent. Moreover, frequently changing the shape(s) of the opaque coverings 130 and the corresponding reference image 140 utilized would further increase the overall difficulty for the fraudster.

### Fourth Security Feature

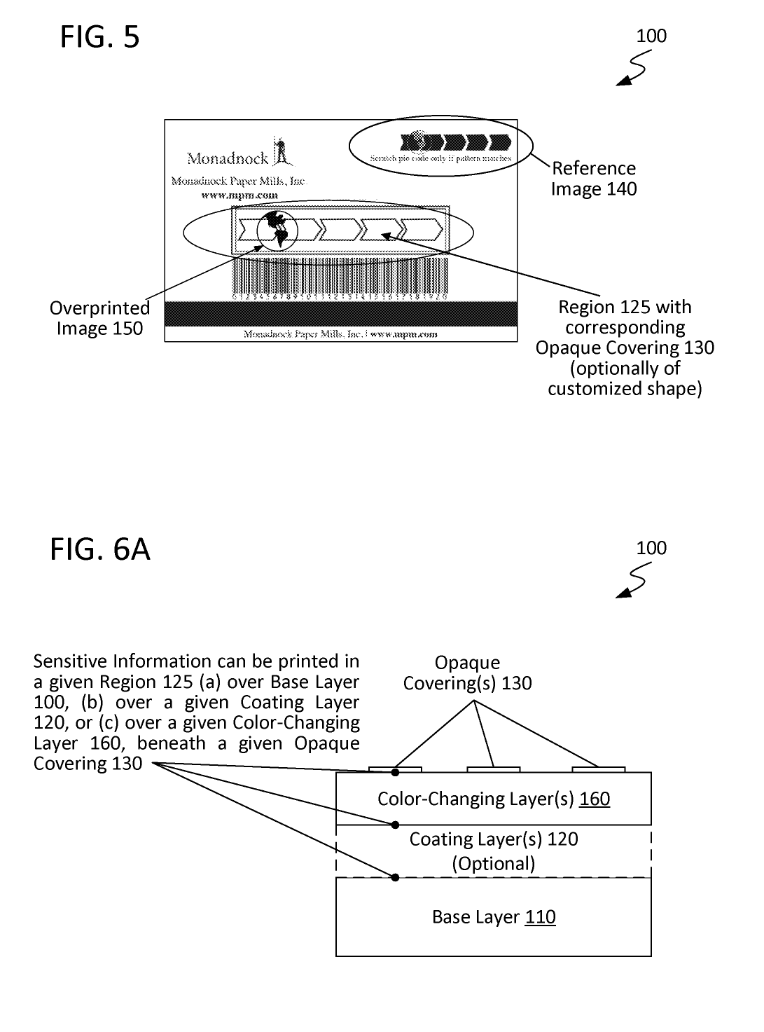

FIG. 5 illustrates a card product 100 implementing another security feature in accordance with an embodiment of the present disclosure. As can be seen here, much like with the embodiments discussed above in relation to FIGS. 2-4, card product 100 again may include a plurality of regions 125 and a corresponding plurality of opaque coverings 130, optionally of one or more customized shapes. In this embodiment, however, card product 100 further may include a reference image 140 printed thereon, an overprinted image or text 150 printed on or across one or more of the opaque coverings 130, and a message warning the consumer that if the observable image or text printed over opaque covering(s) 130 does not match reference image 140 (i.e., if original overprinted image or text 150 is no longer present or is altered), then tampering may be suspected. In some embodiments, overprinted image or text 150 may be printed over a given opaque covering 130 so as to extend beyond that opaque covering 130 onto the underlying layer (e.g., a given coating layer 120 or, if included, color-changing layer 160). Thus, in this configuration, scratching off the relevant opaque covering 130 to access underlying sensitive information necessarily would destroy the overprinted image or text 150, at least in part.

With implementation of this security feature, a fraudster would need to replace or restore scratched-off opaque coverings 130 having precisely the same original overprinted image or text 150 as seen in reference image 140 or else remove both reference image 140 and the warning message altogether. Having to duplicate and realign replacement opaque covering(s) 130 of this type increases the effort required to conceal any tampering and thus serves as a deterrent. Moreover, frequently changing the image 150 printed over the opaque coverings 130 and the corresponding reference image 140 utilized would further increase the overall difficulty for the fraudster.

### Fifth Security Feature

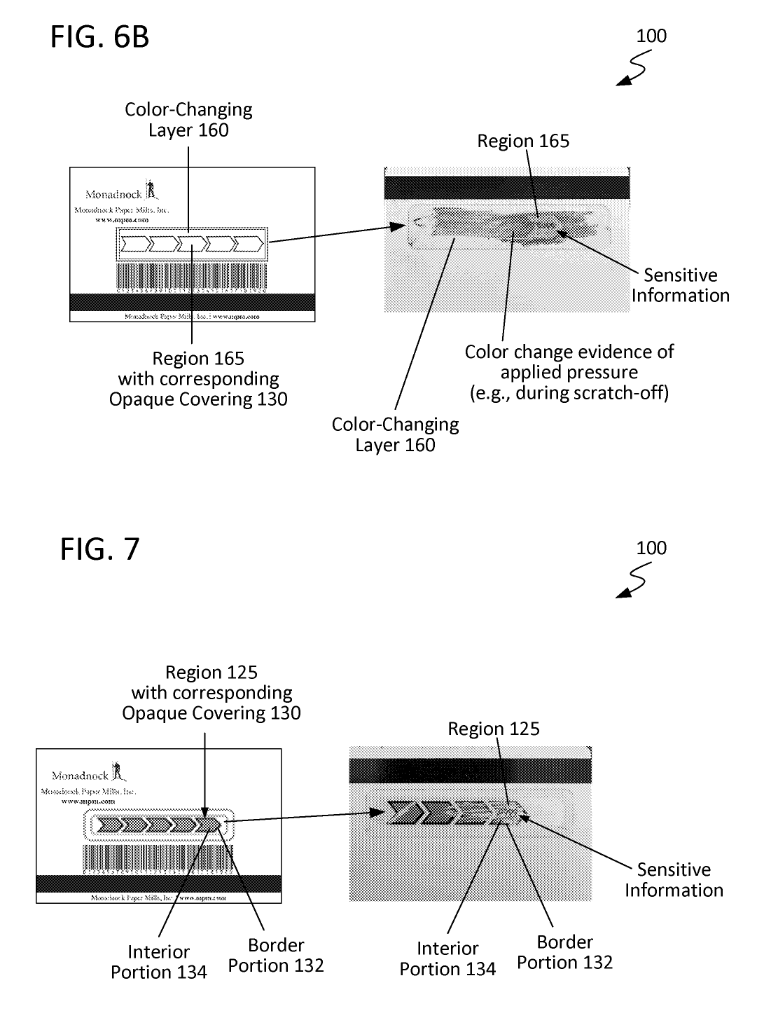

FIGS. 6A-6B illustrate a card product 130 implementing another security feature in accordance with an embodiment of the present disclosure. As can be seen from FIG. 6A, card product 100 may include one or more color-changing layers 160 disposed over coating layer(s) 120, and opaque covering(s) 130 in turn may be disposed over color-changing layer(s) 160 so as to cover a corresponding plurality of regions 165 and attendant sensitive information. More specifically, a given color-changing layer 160 may be disposed directly on (e.g., in direct physical contact with) or indirectly on (e.g., with one or more physically intervening layers) a given underlying coating layer 120. Also, the thickness and uniformity (or non-uniformity) of a given color-changing layer 160 may be customized, as desired for a given target application or end-use.

In accordance with some embodiments, a given color-changing layer 160 may be (or otherwise may include) a pressure-sensitive and/or thermally sensitive layer configured to irreversibly change color when pressure and/or thermal energy (e.g., from friction or other given heat source such as a warm surface, a steam source, a microwave oven, an open flame, a clothing iron or the like, etc.) exceeding a given threshold has been applied. For instance, as generally shown in FIG. 6B, a given color-changing layer 160 may change color irreversibly from (a) an initial color (e.g., white) or an otherwise colorless state to (b) a subsequent color (e.g., a non-white color) or an otherwise colored state. In this manner, a given color-changing layer 160 may serve to provide readily observable visual evidence, for example, that a given opaque covering 130 previously has been scratched off or removed through a heat treatment and replaced. In conjunction with the use of color-changing layer(s) 160, card product 100 also may include a message warning the consumer that if a color change is present, then tampering may be suspected.

To provide the aforementioned color change capability, a given color-changing layer 160 may include, in accordance with some embodiments, a leuco dye material (e.g., a microencapsulated leuco dye), a thermally-sensitive material (e.g., such as is commonly utilized in both direct and indirect thermal tags and labels), or any other suitable color-changing material, as will be apparent in light of this disclosure. The material composition of a given color-changing layer 160 otherwise may be customized, as desired for a given target application or end-use. In some cases, a given color-changing layer 160 may comprise a paper material. In some other cases, a given color-changing layer 160 may comprise a polymer material (e.g., a plastic or composite). In some cases, a given color-changing layer 160 may be formed as (or formed with) a pre-made color-changing label which is applied to card product 100 post-manufacturing. Moreover, it may be desirable, at least in some instances, to ensure that the color change (or other suitable visual evidence) occurs in an oversized area or footprint which is larger than what could be covered up by application of a new, replacement opaque covering 130 by a fraudster.

With implementation of this security feature, a fraudster attempting to scratch off or thermally remove a given opaque covering 130 would trigger an irreversible and readily observable color change of card product 100 through application of sufficient pressure and/or thermal energy, thereby preventing the fraudster from concealing any tampering and thus serving as a deterrent.

### Sixth Security Feature

FIG. 7 illustrates a card product 10 implementing another security feature in accordance with an embodiment of the present disclosure. As can be seen here, much like with the embodiments discussed above in relation to FIGS. 2-5, card product 100 again may include a plurality of regions 125 and a corresponding plurality of opaque coverings 130. In this embodiment, however, any (or all) included opaque coverings 130 may be formed with a border portion 132 of a first color and an interior fill portion 134 of a second color which differs from the first color.

With implementation of this security feature, a fraudster would need to convincingly replace or restore scratched-off opaque covering(s) 130 of multiple colors. Given the limited availability and range of counterfeit opaque coverings, this security feature increases the effort required to conceal any tampering and thus serves as a deterrent.

### Seventh Security Feature

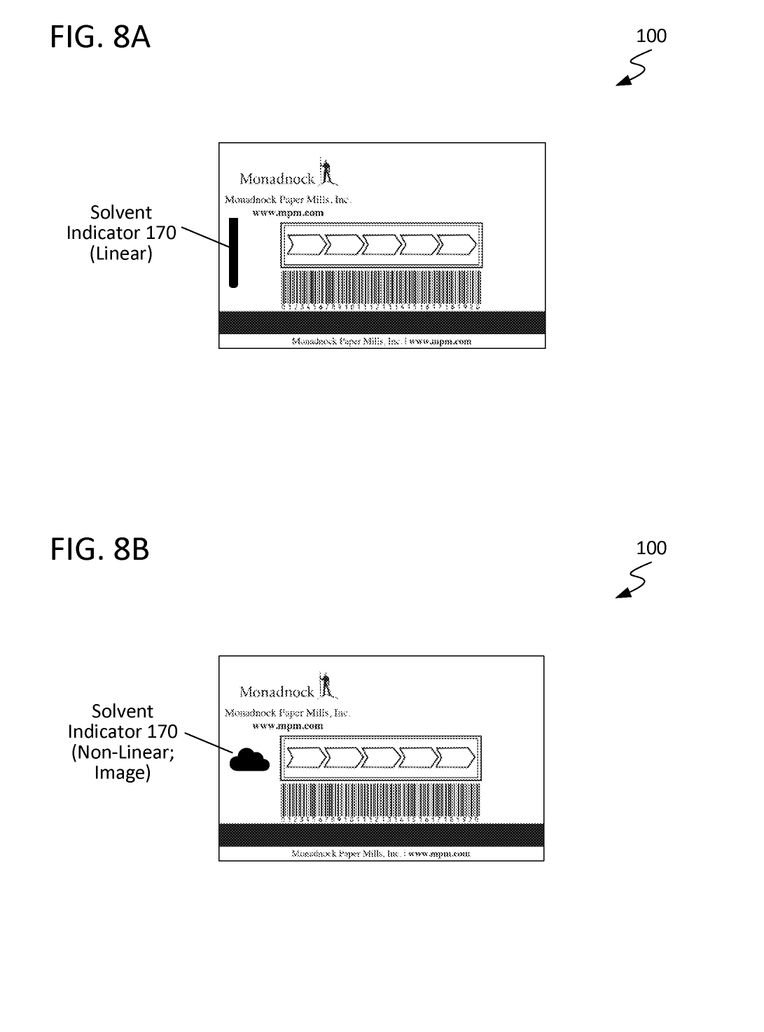

FIGS. 8A-8B illustrate a card product 100 implementing another security feature in accordance with an embodiment of the present disclosure. As can be seen here, card product 100 may be produced with a solvent indicator 170 of linear (see FIG. 8A) or non-linear (see FIG. 8B) configuration. Solvent indicator 170 may be disposed directly on (e.g., in direct physical contact with) or indirectly on (e.g., with one or more physically intervening layers) a given underlying layer (e.g., a coating layer 120 or, if included, a color-changing layer 160). In some cases, solvent indicator 170 may be a surficial feature, whereas in other cases, it may be a feature embedded, in part or in whole, in a given underlying layer.

In accordance with some embodiments, solvent indicator 170 may be configured for chromatographic movement of coloration (e.g., ink spreading) through card product 100 when contacted by a solvent, such as may occur when a fraudster immerses card product 100 in a solvent in effort to remove opaque covering(s) 130 to access sensitive information lying thereunder. Solvent indicator 170 may be reactive to any one (or combination) of solvents, including, for example, acetone, alcohol (e.g., isopropyl alcohol), ethyl acetate, glycol ether, mineral spirits, or other solvent, as may be typically employed by fraudsters.

With implementation of this security feature, a fraudster attempting to remove opaque covering(s) 130 with one or more solvents would trigger an irreversible and readily observable color change of card product 100, preventing the fraudster from concealing any tampering and thus serving as a deterrent.

### Eighth Security Feature

In accordance with some embodiments, another security feature which may be implemented by card product 100 is that of using a cross-linkable adhesive to adhere opaque covering(s) 130 to a given underlying layer (e.g., a given coating layer 120 or, if included, a color-changing layer 160). More specifically, the cross-linkable adhesive may be one which does not degrade in the presence of solvents such as acetone, an alcohol (e.g., isopropyl alcohol), or other solvent as typically may be employed by fraudsters. In some cases, the adhesive may be (or otherwise may include) an ultraviolet (UV) cross-linkable adhesive material.

With implementation of this security feature, a fraudster could not utilize a typical solvent to remove opaque covering(s) 130 adhered in this manner. Moreover, if a color-changing layer 160 is included and the fraudster instead resorts to an abrasive effort to remove opaque covering(s) 130, the fraudster would trigger an irreversible and readily observable color change of card product 100, preventing concealment of any tampering and thus serving as a deterrent.

### Ninth Security Feature

In accordance with some embodiments, another security feature which may be implemented by card product 100 is that of a digital watermark technology, such as that of the Validation product line and software application(s) available from Digimarc Corp. For instance, in accordance with some embodiments, a barcode (or equivalent) may be printed over a given opaque covering 130 so as to extend beyond that opaque covering 130 onto the underlying layer (e.g., a given coating layer 120 or, if included, color-changing layer 160). That barcode may be required for loading funds onto card product 100, and once funds have been loaded onto card product 100, the barcode is no longer needed. Sensitive information required to use the funds may be printed beneath that opaque covering 130. Thus, in this configuration, scratching off the relevant opaque covering 130 to access underlying sensitive information necessarily would destroy the overprinted portion of the barcode.

With implementation of this security feature, if a fraudster applies a new opaque covering 130 in effort to reconceal the sensitive information, the overprinted barcode segment would be missing, and the disrupted barcode would not scan again properly. Given the limited availability and range of counterfeit opaque coverings, this security feature increases the effort required to conceal any tampering and thus serves as a deterrent.

### Security Feature Combination(s)

It further should be noted that, in accordance with some further embodiments of the present disclosure, any two or more of the aforementioned security features may be combined and implemented by a given card product 100. For instance, utilization of a color-changing layer 160 may be combined with any one or more of the other described security features, in accordance with some embodiments. Numerous suitable combinations of the disclosed security features will be apparent in light of this disclosure.

### Specific Example Implementation

In a specific set of example embodiments, card product 100 may be a four-ply, laminated gift card made with virgin fiber, 100% post-consumer waste fiber, or a mixture of both and may be 24-pt., 28-pt., or 30-pt. in overall thickness. In forming such, card product 100 may begin as cardstock meeting these criteria which subsequently undergoes a series of printing, die cutting, scoring, folding, punching, perforating, and affixation to a carrier (if any). A color-changing layer 160 may be applied, and a chevron pattern of opaque coverings 130 may be applied in a post-print label application, for example, by printing a silver-colored latex ink onto an clear label that is later applied to card product 100 to cover sensitive information (e.g., a PIN, barcode, etc.) printed thereon. Other feature(s) of interest may be added offline through label additions and other specialized film application techniques, in accordance with some embodiments.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure not be limited by this detailed description. Future-filed applications claiming priority to this application may claim the disclosed subject matter in a different manner and generally may include any set of one or more limitations as variously disclosed or otherwise demonstrated herein.

What is claimed is:

1. A card product comprising:
a base layer; and
a plurality of abradable opaque coverings disposed over the base layer;
wherein the card product implements at least two of the following security features:
(a) as a first security feature, at least one of the opaque coverings covers sensitive information hosted by the card product, while at least one other of the opaque coverings does not cover sensitive information and so serves as a decoy;
(b) as a second security feature, the opaque coverings are of a custom, non-traditional shape;
(c) as a third security feature, a reference image is printed on the card product, wherein the reference image matches a shape of the opaque coverings;
(d) as a fourth security feature, an image and/or text is printed across at least one of the opaque coverings, and a reference image is printed on the card product, wherein the reference image matches the printed image;
(e) as a fifth security feature, at least one of the opaque coverings includes a border portion of a first color and an interior fill portion of a second color which differs from the first color;
(f) as a sixth security feature, the card product further comprises a color-changing layer disposed over the base layer and having the plurality of opaque coverings disposed thereover, wherein the color-changing layer is configured to irreversibly change color when sufficient pressure and/or thermal energy has been applied thereto;
(g) as a seventh security feature, the card product further comprises a solvent indicator configured for chromatographic movement of coloration through the card product when contacted by a solvent;
(h) as an eighth security feature, at least one of the opaque coverings is adhered via a cross-linkable adhesive; and
(i) as a ninth security feature, the card product further comprises a digital watermark.

2. The card product of claim 1, wherein the custom, non-traditional shape is chevron-shaped.

3. The card product of claim 1, wherein the custom, non-traditional shape comprises a plurality of adjacent shapes which are spaced apart from one another with corresponding gaps intervening therebetween.

4. The card product of claim 1, wherein the third security feature further includes a message warning against purchase of the card product if the reference image and opaque coverings are of differing shapes.

5. The card product of claim 1, wherein the fourth security feature further includes a message warning against purchase of the card product if the reference image and/or text and the printed image are different.

6. The card product of claim 1, wherein the color-changing layer comprises at least one of:
a pressure-sensitive material; and
a thermally sensitive material.

7. The card product of claim 1, wherein the color-changing layer comprises a leuco dye.

8. The card product of claim 1, wherein the color-changing layer comprises protonated bentonite clay.

9. The card product of claim 1, wherein the color-changing layer comprises silica.

10. The card product of claim 1, wherein the color-changing layer further comprises a paper material.

11. The card product of claim 1, wherein the color-changing layer further comprises a polymer material.

12. The card product of claim 1, wherein the sixth security feature further includes a message warning against purchase of the card product if a color change is present in the card product.

13. The card product of claim 1, wherein the solvent comprises at least one of acetone, isopropyl alcohol, ethyl acetate, glycol ether, and mineral spirits.

14. The card product of claim 1, wherein the solvent indicator is at least partially embedded in an underlying layer.

15. The card product of claim 1, wherein the solvent indicator is linear in shape.

16. The card product of claim 1, wherein the solvent indicator is non-linear in shape.

17. The card product of claim 1, wherein the seventh security feature further includes a message warning against purchase of the card product if a color change is present in the card product.

18. The card product of claim 1, wherein the cross-linkable adhesive is an ultraviolet (UV) cross-linkable adhesive.

19. The card product of claim 1, wherein the digital watermark comprises a barcode printed on at least one of the opaque coverings.

20. A gift card comprising the card product of claim 1.

21. A lottery scratchcard or ticket comprising the card product of claim 1.

22. Food packaging comprising the card product of claim 1.

23. Medication packaging comprising the card product of claim 1.

24. A card product comprising:
a base layer;
a color-changing layer disposed over the base layer, wherein the color-changing layer is configured to irreversibly change color when sufficient pressure and/or thermal energy has been applied thereto; and
at least one abradable opaque covering disposed over the color-changing layer.
